(19) United States
(12) Patent Application Publication
(10) Pub. No.: US 2014/0183118 A1
(43) Pub. Date: Jul. 3, 2014

(54) SLIP THREAD LOCKING HEAD WITH INTERACTIVE ELEMENT

(71) Applicant: Evan Marks, Toledo, OH (US)

(72) Inventor: Evan Marks, Toledo, OH (US)

(21) Appl. No.: 14/237,203

(22) PCT Filed: Aug. 6, 2012
(86) PCT No.: PCT/US12/49745

§ 371 Date: Feb. 5, 2014

Related U.S. Application Data
(60) Provisional application No. 61/515,343, filed on Aug. 5, 2011.

(51) Int. Cl. B01D 27/10; B01D 27/08

(52) U.S. Cl. CPC B01D 27/10; B01D 27/08
USPC 210/236; 29/428

(57) ABSTRACT

Provided is a filter element includes an end cap having at least one stop member extending radially outwardly from an outer surface, the at least stop member having at least one stop surface for contacting a tab on a slip thread collar of a filter head assembly. When the filter element is coupled to the filter head assembly, the filter element prevents rotation of the slip thread collar relative to a filter head, thereby allowing threads on the slip thread collar to mate with threads on a filter bowl to couple the filter head assembly to the filter bowl. The interaction between the filter element and filter head assembly prevents the filter head assembly from being coupled to the filter bowl when the filter element is not installed.

### RELATED APPLICATIONS

This application claims the benefit of U.S. Provisional Application No. 61/515,343 filed Aug. 5, 2011, which is hereby incorporated herein by reference.

### FIELD OF THE INVENTION

The present invention relates generally to filter assemblies, and more particularly to filter elements and filter heads for filter assemblies.

### BACKGROUND

Filter assemblies have been employed in a variety of applications including hydraulic systems, fuel systems and engine lubrication systems. High pressure hydraulic systems, for example, require long component life and high performance standards. To accomplish the foregoing, hydraulic components are built with tight tolerances, which increase sensitivity to contamination. Filter assemblies can be used to filter out ingressed contamination before the contamination jams a valve or scores a cylinder, to block pump generated debris before it reaches servo and proportional valves in the hydraulic systems, etc.

The filter assemblies can include a filter media such as a sheet of filter material folded to form a plurality of parallel pleats or folds. The side edges of the sheet are brought together so that the sheet has a cylindrical configuration, with the pleats of the sheet extending in the axial or longitudinal direction. The side edges of the sheet are then joined together such as with adhesive, stitching or other means, to retain the filter material in the cylindrical form. The media can be imparted with resin, and/or an outer or inner mesh sheet, weave, mesh or cage can be provided for strength, if necessary or desirable. The wire reinforcement prevents the pleats from bunching, prevents media migration, and maintains media efficiency. By preventing the pleats from bunching, for example, the wire reinforcement prevent the effective surface area of the filter from being reduced and prevents excessive pressure drop.

### SUMMARY OF INVENTION

The present invention provides a filter element includes an end cap having at least one stop member extending radially outwardly from an outer surface, the at least stop member having at least one stop surface for contacting a tab on a slip thread collar of a filter head assembly. When the filter element is coupled to the filter head assembly, the filter element prevents rotation of the slip thread collar relative to a filter head, thereby allowing threads on the slip thread collar to mate with threads on a filter bowl to couple the filter head assembly to the filter bowl. The interaction between the filter element and filter head assembly prevents the filter head assembly from being coupled to the filter bowl when the filter element is not installed.

According to one aspect of the invention, a filter element is provided that includes at least one end cap including a body having a cavity defined at a bottom portion of the body, at least one stop member extending radially outwardly from an outer surface of the body, the at least stop member having at least one stop surface for contacting a tab on a slip thread collar of a filter head assembly to prevent rotation of the slip thread collar, and at least one groove or protrusion for mating with a groove or protrusion on the filter head assembly to prevent rotation of the end cap relative to the filter head assembly, and a filter media having one end disposed in the cavity and secured to the end cap.

In an embodiment, the at least one end cap includes a first member having a flange portion defining the cavity, a cylindrical portion extending from the flange portion, and a plurality of circumferentially spaced fingers extending radially outwardly from the cylindrical portion, and a second member having an outer surface from which the at least one stop member extends and an inner surface including the at least one groove or protrusion and a plurality of circumferentially spaced slots configured to mate with corresponding fingers extending from the cylindrical portion, wherein the second member at least partially surrounds the first member when coupled thereto.

In another embodiment, the at least one groove or protrusion is at least one groove for mating with a protrusion on the filter head assembly.

In yet another embodiment, the cylindrical portion includes an opening defining a first fluid passage through the end cap.

In still another embodiment, an outer wall of the cylindrical portion defines with the inner surface of the second member a second fluid passage through the end cap.

In a further embodiment fluid flows through the second fluid passage, into the filter media and then out of the filter element through the first fluid passage.

In another embodiment, the plurality of circumferentially spaced fingers are substantially C-shaped.

In yet another embodiment, the substantially C-shaped fingers each include a tap at an outer end thereof that mates with the corresponding slot.

In still another embodiment, the first member includes a radially outwardly opening groove at an end of the cylindrical portion opposite the flange portion that receives a seal to seal the top end cap assembly to the filter head assembly.

In a further embodiment, the at least one groove or protrusion includes two grooves or protrusions spaced apart about the circumference of the inner surface.

In another embodiment, the second member includes a first radially outwardly opening groove at a first end of the second member and a second radially outwardly opening groove at a second end of the second member that each receive a seal to seal the top end cap assembly to the filter head assembly and a filter bowl respectively.

In yet another embodiment, the at least one stop member includes two stop surfaces at opposites ends of the stop member.

In still another embodiment, the at least one stop member includes two stop members circumferentially spaced from one another.

In a further embodiment, the filter element further includes a second end cap having a cavity defined therein, wherein a second end of the filter media is disposed in the cavity and secured to the second end cap.

In another embodiment, the filter media is a wire reinforced pleated filter media.

According to another aspect of the invention a filter assembly is provided that includes a filter bowl having threads on an outer wall thereof, a filter head assembly configured to be coupled to the filter bowl, the filter head assembly including a filter head and a slip thread collar, the filter head defining a cavity and having a groove or protrusion in the cavity extending from a wall of the filter head, and the slip thread collar being disposed in the cavity and rotatable relative to the filter head, the slip thread collar having threads on an inner surface and a tab extending radially inwardly from the inner surface, at least one end cap having a cavity defined therein, at least one groove or protrusion for mating with a groove or protrusion on the filter head to prevent rotation of the end cap relative to the filter head, and a stop member extending radially outwardly from an outer surface of the end cap, the stop member having at least one stop surface for contacting the tab, and a filter media having one end disposed in the cavity and secured to the end cap, wherein the at least one end cap and the filter media are disposed within the filter head assembly and filter bowl when assembled, and wherein when the tab contacts the stop surface, the slip thread collar is prevented from rotating relative to the filter head, thereby allowing the threads on the slip thread collar to mate with the threads on the filter bowl to couple the filter head assembly to the filter bowl.

In an embodiment, the filter head assembly further includes a retainer ring disposed in the cavity in the filter head for retaining the slip thread collar in the filter head.

In another embodiment, the filter head assembly further includes a slip thread locking collar disposed in the cavity in the filter head, the slip thread locking collar being configured to couple to the filter head to lock the slip thread collar and retainer ring in the filter head.

In yet another embodiment, the filter assembly further includes a second end cap having a cavity defined therein, wherein a second end of the filter media is disposed in the cavity and secured to the second end cap.

In still another embodiment, the at least one end cap includes a first member having a flange portion defining the cavity, a cylindrical portion extending from the flange portion, and a plurality of circumferentially spaced fingers extending radially outwardly from the cylindrical portion, and a second member having an outer surface from which the at least one stop member extends and an inner surface including the at least one groove or protrusion and a plurality of circumferentially spaced slots configured to mate with corresponding fingers extending from the cylindrical portion, wherein the second member at least partially surrounds the first member when coupled thereto.

In a further embodiment, the at least one groove or protrusion is at least one groove for mating with a protrusion on the filter head assembly.

In another embodiment, the cylindrical portion includes an opening defining a first fluid passage through the end cap.

In yet another embodiment, an outer wall of the cylindrical portion defines with the inner surface of the second member a second fluid passage through the end cap.

In still another embodiment, fluid flows through the second fluid passage, into the filter media and then out of the filter through the first fluid passage.

In a further embodiment, the plurality of circumferentially spaced fingers are substantially C-shaped.

In another embodiment, the substantially C-shaped fingers each include a tap at an outer end thereof that mates with the corresponding slot.

In yet another embodiment, the first member includes a radially outwardly opening groove at an end of the cylindrical portion opposite the flange portion that receives a seal to seal the top end cap assembly to the filter head assembly.

In still another embodiment, the at least one groove or protrusion includes two grooves or protrusions spaced apart about the circumference of the inner surface.

In a further embodiment, the second member includes a first radially outwardly opening groove at a first end of the second member and a second radially outwardly opening groove at a second end of the second member that each receive a seal to seal the top end cap assembly to the filter head assembly and a filter bowl respectively.

In another embodiment, the at least one stop member includes two stop surfaces at opposites ends of the stop member.

In yet another embodiment, the at least one stop member includes two stop members circumferentially spaced from one another.

In still another embodiment, the filter assembly further includes a second end cap having a cavity defined therein, wherein a second end of the filter media is disposed in the cavity and secured to the second end cap.

In a further embodiment, the filter media is a wire reinforced pleated filter media.

In another embodiment, the filter head further includes first and second openings in a wall of the filter head, and wherein one of the openings is configured to receive fluid and one of the openings in configured to expel fluid.

According to yet another aspect of the invention, a filter head defining a cavity, the filter head including an annular protrusion extending into the cavity from an end wall of the filter head and at least one tab extending radially outwardly from the protrusion, a slip thread collar disposed in the cavity and rotatable relative to the filter head, a retainer ring disposed in the cavity, the retainer ring retaining the slip thread collar in position in the filter head, and a slip thread locking collar disposed in the cavity and coupled to the filter head to lock the slip thread collar and retainer ring in the filter head.

In an embodiment, the filter head further includes first and second openings in a wall of the filter head, and wherein one of the openings is configured to receive fluid and one of the openings in configured to expel fluid.

In another embodiment, the slip thread collar includes threads on an inner surface that are configured to mate with threads on a filter bowl.

In yet another embodiment, the slip thread collar further includes at least one tab extending radially inwardly from the inner surface, the tab being configured to contact a stop surface on an end cap assembly to prevent the slip thread collar from rotating relative to the filter head to allow the threads on the slip thread collar to mate with the threads on the filter bowl to couple the filter head assembly to the filter bowl.

According to still another aspect of the invention, a method of assembling a filter assembly is provided. The filter assembly includes a filter bowl having threads on an outer wall thereof, a filter head assembly having a filter head defining a cavity and a slip thread collar disposed in the cavity and rotatable relative to the filter head, and a filter element having at least one end cap having a cavity defined therein and a filter media having one end disposed in the cavity and secured to the end cap. The method includes inserting a first end of the filter element into the cavity of the filter head, rotating the filter element until a groove or protrusion extending from a wall of the filter head mates with a groove or protrusion on the filter element to prevent rotation of the filter element relative to the filter head, inserting the filter bowl into the cavity of the filter head, and rotating the filter bowl relative to the filter head, wherein rotating the filter bowl causes a tab on the slip thread collar to contact a stop surface on the filter element to prevent rotation of the slip thread collar relative to the filter head to allow the threads on the filter bowl to engage threads on the slip thread collar to couple the filter head assembly to the filter bowl.

The foregoing and other features of the invention are hereinafter described in greater detail with reference to the accompanying drawings.

### BRIEF DESCRIPTION OF THE DRAWINGS

FIG. 1 is a perspective view of an exemplary filter assembly in accordance with the invention;

FIG. 2 is an exploded view of an exemplary filter element in accordance with the invention;

FIG. 3 is an exploded view of an exemplary top end cap assembly in accordance with the invention;

FIG. 4 is a perspective view of the exemplary top end cap assembly;

FIG. 5 is a side view of the exemplary top end cap assembly;

FIG. 6 is a top view of the exemplary top end cap assembly

FIG. 7 is an exploded view of an exemplary filter head assembly in accordance with the invention;

FIG. 8 is a perspective view of the exemplary filter head assembly;

FIG. 9 is an end view of the exemplary filter head assembly;

FIG. 10 is cross-sectional view of the top end cap assembly positioned in the filter head assembly;

FIG. 11 is an end view of an exemplary filter head; and

FIG. 12 is another cross-sectional view of the top end cap assembly positioned in the filter head assembly.

### DETAILED DESCRIPTION

The principles of the present application have particular application to filter assemblies for hydraulic systems, water systems for mining devices, etc. It will of course be appreciated, and also understood, that the principles of the invention may be useful in other applications where filtration of contamination from fluid is desired.

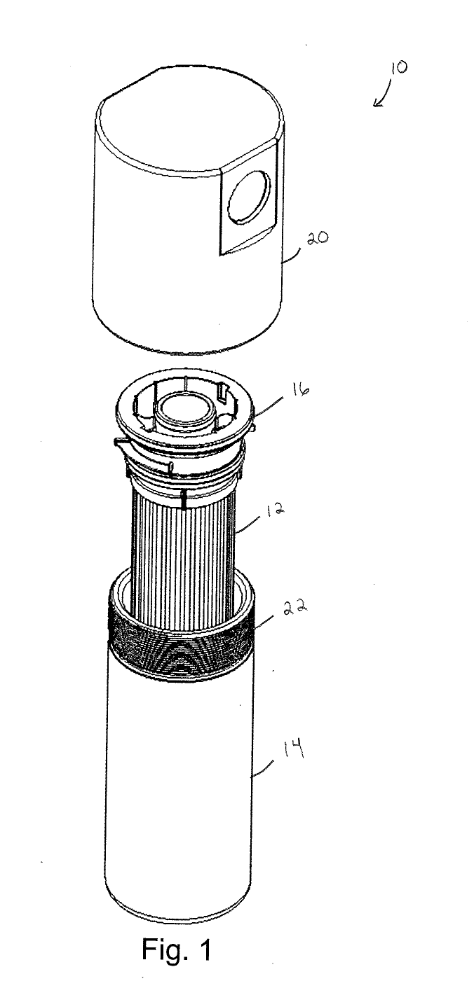

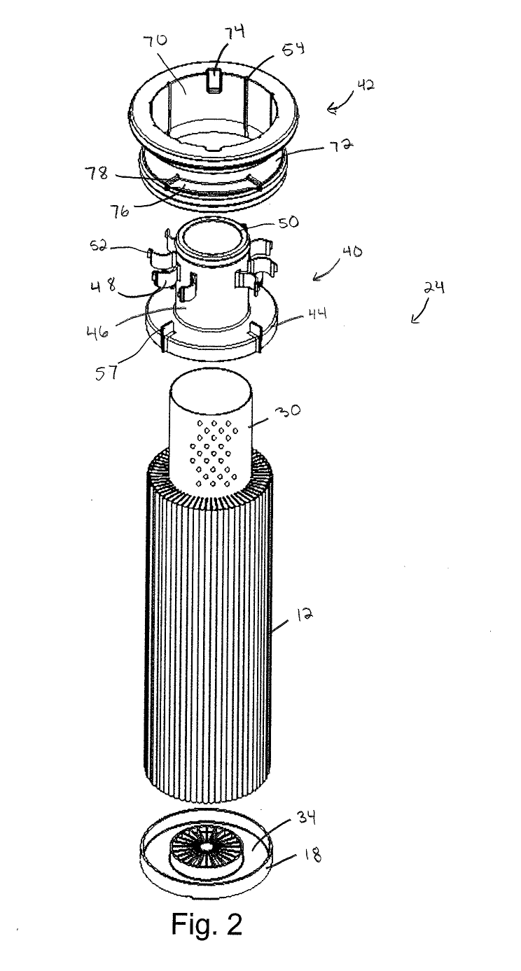

Referring now to the drawings in detail, and initially to FIG. 1, an exemplary filter assembly is illustrated generally at 10. The filter assembly includes a filter media 12, a filter bowl 14 surrounding the filter media 12, top and bottom end cap assemblies 16 and 18 (FIG. 2) coupled to the filter media 12, and a filter head assembly 20 configured to couple to the filter bowl 14. The filter head assembly 20 may be coupled to the filter bowl 14 in any suitable manner, such as by threads on the filter head assembly mating with threads 22 on an outer circumferential surface of the filter bowl, as will be described in detail below.

The filter media 12 may be any suitable media, such as a wire reinforced pleated filter media or a non-pleated media. The filter media may be coreless, i.e., self-supporting, and received over a cylindrical perforated support tube 30 (FIG. 2) integral with the filter media 12, the filter bowl 14 or the bottom end cap assembly 18 when the filter media 12 is located in the filter bowl 14. The filter media 12 may form around the support tube 30 to maintain a shape substantially similar to the support tube 30.

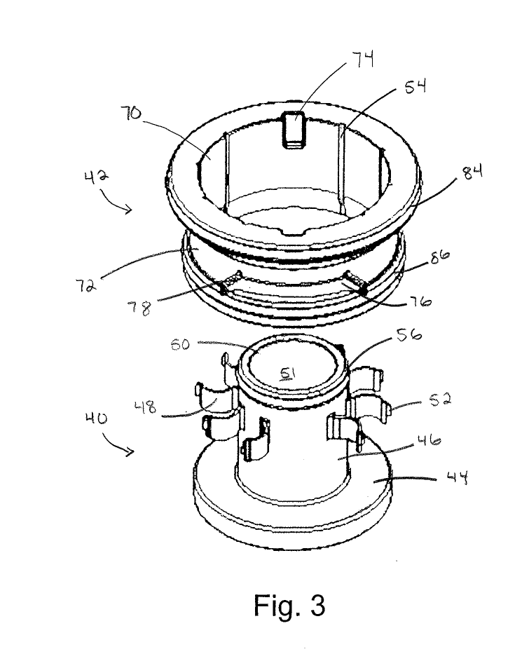

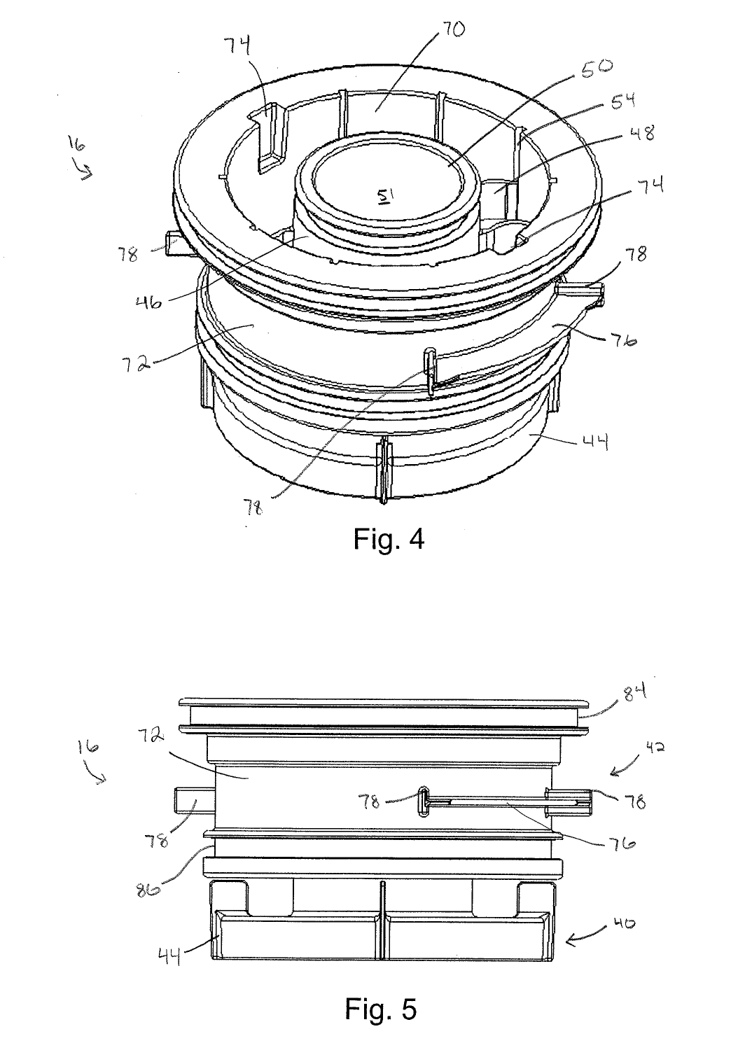

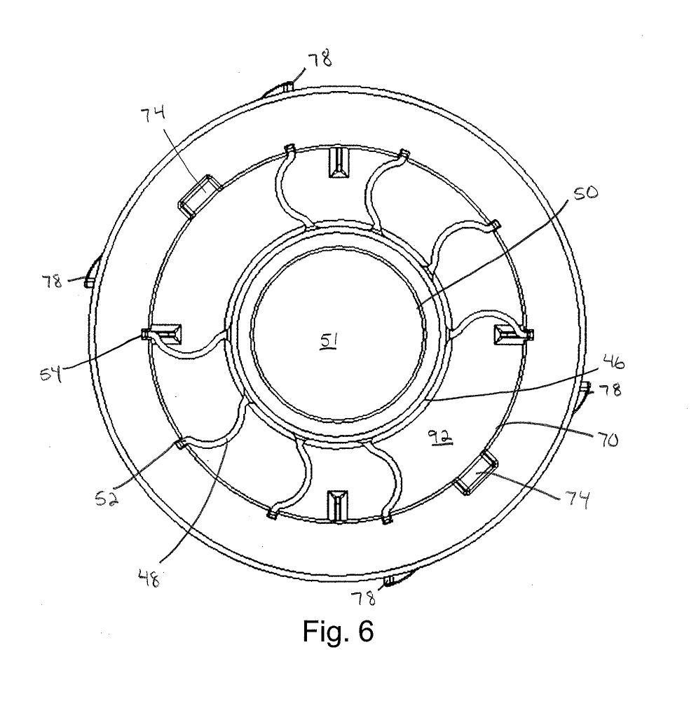

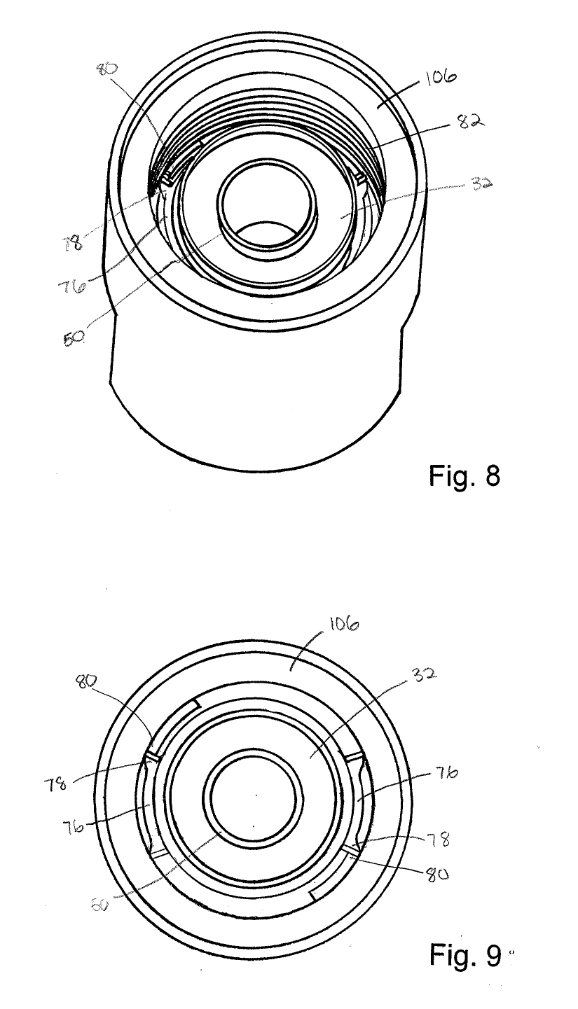

Turning now to FIGS. 2-6, and initially to FIG. 2, the end cap assemblies 16 and 18 may be attached on respective ends of the filter media 12 in any suitable manner, such as by sealingly bonding the filter media to the end caps. The filter media 12 and end cap assemblies 16 and 18 form a filter element 24 when coupled together. The top end cap assembly 16 may include a cavity 32 (FIG. 8) and the bottom end cap assembly 18 may include a cavity 34 defined therein for receiving respective ends of the filter media 12. The end cap assemblies may also include at least one retainer mechanically locked to the end cap assemblies in the cavity and defining a region into which bonding agent can flow to form a mechanical interlock with the retainer, for example as described in International Application No. PCT/US12/38474 which is hereby incorporated herein by reference.

Referring now to the top end cap assembly 16 in detail, the top end cap assembly 16 is provided to interconnect with the filter head assembly 20 to allow the filter head assembly 20 to connect to the filter bowl 14 as will be described in detail below. The top end cap assembly 16 may be a one-piece end cap or formed as two or more pieces coupled together in any suitable manner. For example, the top end cap assembly 16 may include first member 40 and a second member 42 that at least partially surrounds the first member 40 when coupled thereto. The first member 40 includes a flange portion 44 defining the cavity 32, a cylindrical portion 46 extending from the flange portion, a plurality of circumferentially spaced fingers 48 extending radially outwardly from the cylindrical portion, and a central opening 50 defining a fluid passage 51 through the first portion. The plurality of circumferentially spaced fingers 48 may be any suitable shape, such as curved or straight in shape. In one embodiment, the fingers may be substantially C-shaped and include a tab 52 at an outer end of the fingers to be received in a corresponding slot 54 in the second member 42. The curved shaped of the fingers 48 allows the fingers to deflect and snap into the slots 54, and the tabs 52 facilitate locking of the fingers 48 into the slots 54.

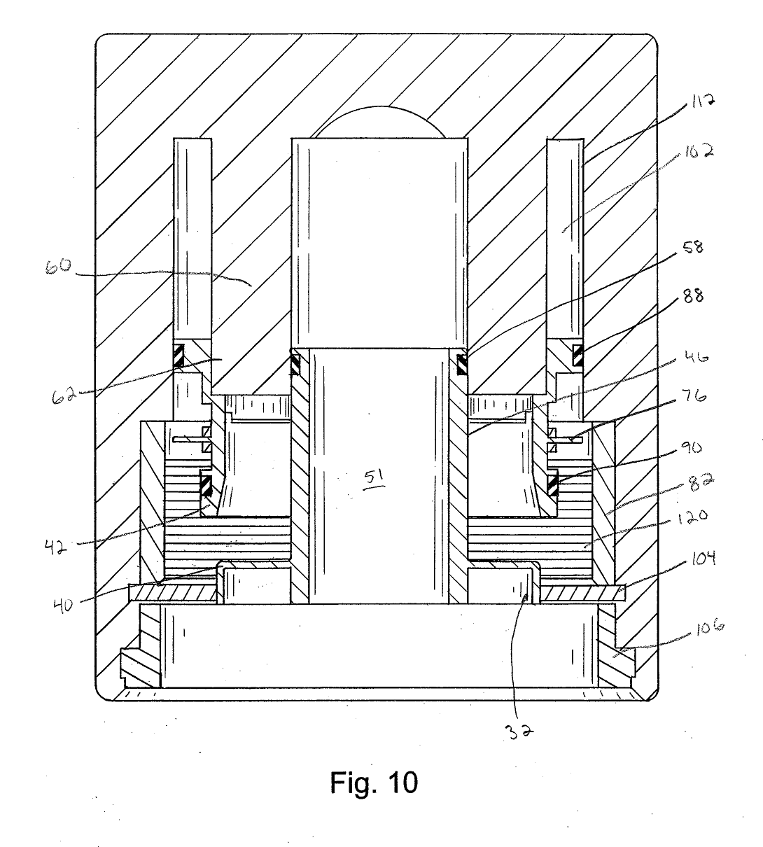

The first portion 40 also includes a radially outwardly opening groove 56 at an end of cylindrical portion 46 opposite the flange portion 44, and at least one tab 57 projecting upward and radially outward from the flange portion 44. The groove 56 receives a suitable seal, such as o-ring 58 (FIG. 10), which seals the top end cap assembly 16, and more particularly the fluid passage defined by the central opening 50, to an inner wall of an annular protrusion 60 (FIG. 10) of the filter head assembly. The at least one tab 57 extends outward from the flange portion 44 to provide an interference fit with an inner circumferential surface 70 of the second member to assist in the connection between the first and second members 40 and 42. For example, the flange portion may have a diameter that is less than an inner diameter of the second member, and the tabs 57 create the interference fit between the two members. Alternatively, the flange portion 44 may have a diameter substantially equal to the inner diameter of the second member to create the interference fit, and the tabs 57 may or may not be included.

Referring now to the second member 42 in detail, the second member has a substantially cylindrical body having the inner circumferential surface 70 and an outer circumferential surface 72. The inner surface includes at least one groove or protrusion, and in the illustrated embodiment two grooves 74 for mating with tabs 62 (FIG. 10) extending outward from the protrusion 60 to prevent rotation of the end cap relative to the filter head assembly 20. The inner surface 70 also includes the slots 54 that are circumferentially spaced about the inner surface for mating with respective fingers 48.

Extending radially outwardly from the outer surface 72 is at least one stop member 76 having at least one stop surface 78, and in the illustrated embodiment two stop members 76 each having two stop surfaces 78. When assembled in the filter head assembly 20, one of the stop surfaces 78 on each stop member 76 contacts a tab 80 (FIG. 8) extending radially inwardly from an inner surface of a slip thread collar 82 (FIG. 8) of the filter head assembly 20. The interaction between the stop surface 78 and the tab 80 acts to prevent rotation of the slip thread collar 82 when the filter assembly is assembled.

The outer surface 72 also includes first and second seal grooves 84 and 86 that receive suitable seals, such as o-rings 88 and 90 (FIG. 10). The first seal groove 84 is provided at a top portion of the outer surface 72 and the second seal groove 86 is provided at a bottom portion of the outer surface. The o-ring 88 prevents fluid flow between the second member 42 and the filter head assembly 20, and the second o-ring 90 prevents fluid flow between the second member 42 and the filter bowl 14.

When the first and second members 40 and 42 are coupled together, the outer wall of the cylindrical portion 46 defines with the inner surface 70 a fluid passage 92 through the end cap. Fluid, such as air, fuel, oil, hydraulic fluid, etc., entering the filter head assembly 20 flows through the fluid passage 92 and into the filter media 12, from the outside to the inside of the filter media 12, where particulates and other contaminants are removed from the fluid. The fluid then flows from the filter media through the flow passage 51 and out of the end cap assembly 16 to the filter head assembly 20. Alternatively, fluid may flow through the fluid passage 51 to the inside of the filter media and then through the filter media to the outside of the filter media. The fluid then flows from outside the filter media to the fluid passage 92 and out the filter head assembly 20. As noted above, it should be appreciated that the first and second members may be formed as a single member including the stop members for preventing rotation of the slip thread collar.

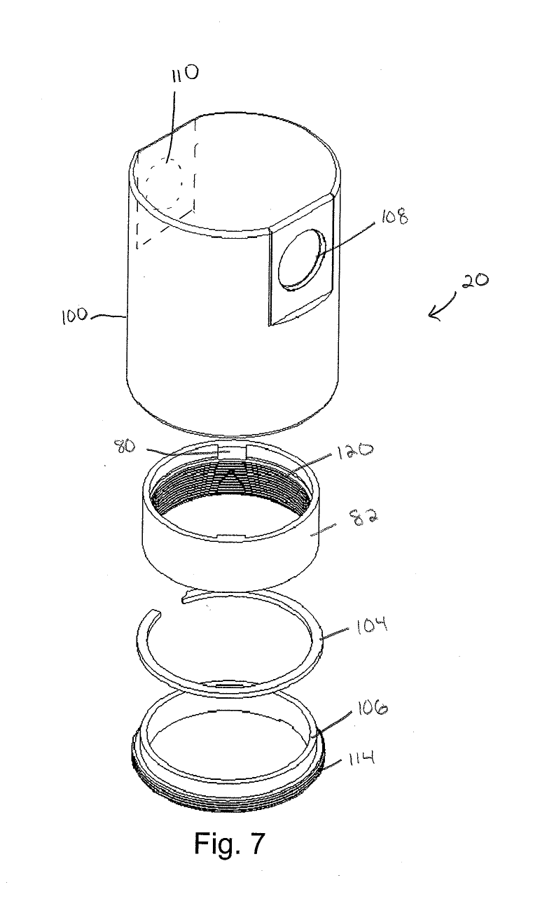

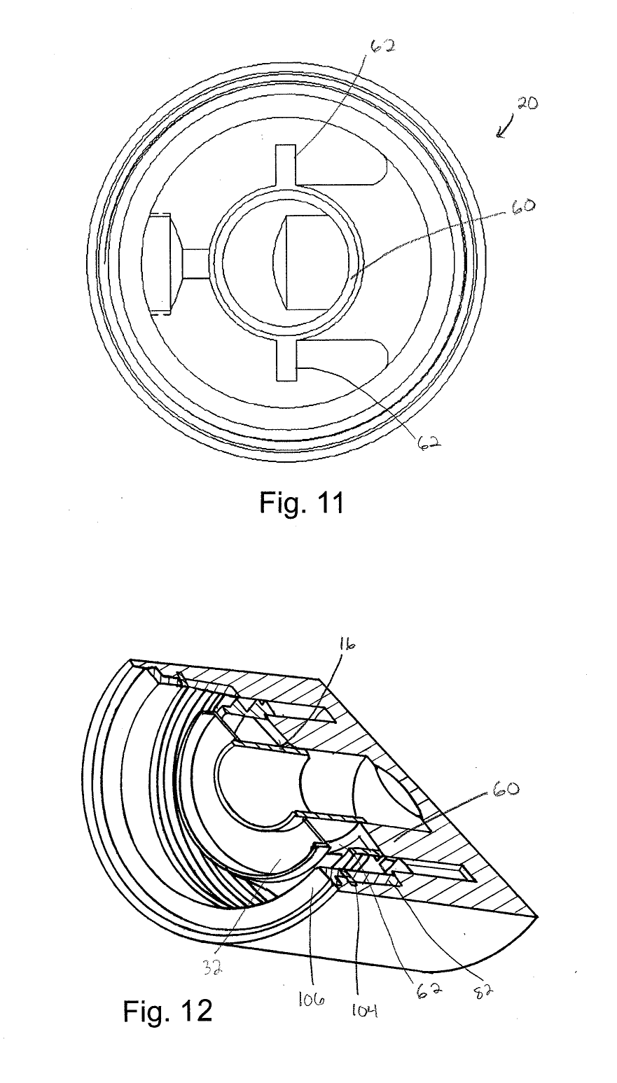

Turning now to FIGS. 7-12, the filter head assembly 20 includes a filter head 100 defining a cavity 102 in which is disposed the slip thread collar 82, a retainer ring 104, and a slip thread locking collar 106. The filter head 100 includes a first opening 108 for receiving/expelling fluid and a second opening 110 for receiving/expelling fluid. The first opening 108 is in fluidic communication with the fluid passage 92 for delivering fluid to the filter media and the second opening 110 is in fluidic communication with the fluid passage 51 for expelling filtered fluid. The filter head 100 also includes the protrusion 60 having the pair of tabs 62 extending radially outwardly from the protrusion 60, the tabs mating with the grooves 74 to prevent rotation of the end cap assembly 16 relative to the filter head 100.

As noted above, the slip thread collar 82 is inserted into the cavity 102 and held in place by the retainer ring 104, which locks into a groove in the filter head 100 and acts as a ledge for the slip thread collar. When positioned in the cavity 102, the slip thread collar 82 is rotatable on the ledge relative to the filter head 100. The slip thread collar 82 includes threads 120 that are configured to mate with the threads 22 on the filter bowl 14 when the filter head assembly is coupled to the filter bowl. The slip thread collar 82 also includes the at least one tab 80, and in the illustrated embodiment two tabs 80, that contact the stop surfaces 78 on respective stop members 76 to prevent the slip thread collar 82 from rotating relative to the filter head 100.

After the slip thread collar 82 and retainer ring 104 have been positioned in the filter head, the slip thread locking collar 106 is inserted into the cavity and coupled to an inner surface 112 of the filter head 20 in any suitable manner. For example, the slip thread locking collar 106 includes threads 114 on an outer surface thereof configured to mate with threads (not shown) on the inner surface 112 to couple to the slip thread locking collar 106 to the filter head. Additionally or alternatively, a bonding agent may be used to permanently couple the slip thread locking collar 106 to the filter head to lock the slip thread collar 82 and retainer ring 104 in the filter head 100.

Referring again to FIGS. 1 and 10, the assembly of the filter assembly 10 will be discussed in detail. The filter element 24 is first assembled by sealingly bonding the end cap assemblies 16 and 18 to the filter media 12. The filter element 24 is then inserted into the filter head assembly 20 and rotated until the tabs 62 extending from the protrusion 60 mate with the respective grooves 74 in the top end cap assembly 16. In this way, the filter element 24 is prevented from rotating relative to the filter head assembly 20. The filter bowl 14 is then inserted into the filter head assembly 20 until the threads 22 are in contact with the threads 120 on the slip thread collar 82. At this time, the stop surfaces 78 on the stop members may or may not be in contact with the tabs 80 to prevent the slip thread collar 82 from rotating relative to the filter head assembly 20. If the tabs 80 are not in contact with a respective stop surface 78, rotation of the filter bowl 14 will cause the slip thread collar 82 to rotate until the tabs 80 are in contact with the respective stop surface 78 and thereby prevented from rotating. When this occurs, rotation of the filter bowl 14 within the filter head assembly 20 causes the threads 22 to engage the threads 120 to couple the filter head assembly 20 to the filter bowl 14.

When the filter assembly 10 is assembled, the protrusion 60 is sealed to the cylindrical portion 46 via o-ring 58 to prevent fluid leakage from the fluid passage 51. Additionally, the inner surface 102 of the filter head 100 is sealed to the second member 42 by o-ring 88 and an inner surface of the filter bowl 14 is sealed to the second member by o-ring 90 to prevent fluid leakage from the fluid passage 92.

During operation, fluid is received from a fluid source at the opening 108. The fluid flows between the outer surface of the protrusion 60 and the inner surface 112 to the fluid passage 92 in-between the fingers 48. The fluid flows through the passage 92 into the filter bowl 14, where the fluid flows into the filter media 12 and particulates and other contaminants are removed from the fluid. The fluid then flows out of the filter media 12 into the fluid passage 51 and to the fluid passage formed by the protrusion 60. The filtered fluid then exits the filter head assembly 20 via the opening 110. Alternatively, fluid is received from a fluid source at the opening 110. The fluid flows through fluid passage formed by the protrusion 60 and to the fluid passage 51. The fluid then flows to the inside of the filter media 12 and towards the outside of the filter media. The fluid then flows out of the filter media into the filter bowl 14, where the fluid flows to the fluid passage 92 in-between the fingers 48. The fluid then flows between the outer surface of the protrusion 60 and the inner surface 112 and exits the filter head assembly 20 via the opening 108.

As should be appreciated, the filter assembly 10 provides a bowl-down filter assembly for use for any suitable pressure and material, although it will be appreciated that a bowl-up assembly may also be provided. Using the filter assembly 10, a filter assembly is provided wherein a replaceable filter can be used and wherein the filter head assembly 20 is prevented from being coupled to the filter bowl 14 when the end cap and filter media are not installed.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A filter element including:
at least one end cap including:
a body having a cavity defined at a bottom portion of the body; at least one stop member extending radially outwardly from an outer surface of the body, the at least one stop member having at least one stop surface for contacting a tab on a slip thread collar of a filter head assembly to prevent rotation of the slip thread collar;
at least one groove or protrusion for mating with a groove or protrusion on the filter head assembly to prevent rotation of the end cap relative to the filter head assembly;
a first member having a flange portion defining the cavity, a cylindrical portion extending from the flange portion, and a plurality of circumferentially spaced fingers extending radially outwardly from the cylindrical portion; and
a second member having an outer surface from which the at least one stop member extends and an inner surface including the at least one groove or protrusion and a plurality of circumferentially spaced slots configured to mate with corresponding fingers extending from the cylindrical portion, wherein the second member at least partially surrounds the first member when coupled thereto; and
a filter media having one end disposed in the cavity and secured to the end cap.

2. (canceled)

3. A filter element according to claim 1, wherein the at least one groove or protrusion is at least one groove for mating with a protrusion on the filter head assembly.

4. A filter element according to claim 1, wherein the cylindrical portion includes an opening defining a first fluid passage through the end cap.

5. A filter element according to claim 4, wherein an outer wall of the cylindrical portion defines with the inner surface of the second member a second fluid passage through the end cap.

6. A filter element according to claim 5, wherein fluid flows through the second fluid passage, into the filter media and then out of the filter element through the first fluid passage.

7. A filter element according to claim 1, wherein the plurality of circumferentially spaced fingers are substantially C-shaped.

8. A filter element according to claim 7, wherein the substantially C-shaped fingers each include a tap at an outer end thereof that mates with the corresponding slot.

9. A filter element assembly according to claim 1, wherein the first member includes a radially outwardly opening groove at an end of the cylindrical portion opposite the flange portion that receives a seal to seal the top end cap assembly to the filter head assembly.

10. A filter element according to claim 1, wherein the at least one groove or protrusion includes two grooves or protrusions spaced apart about the circumference of the inner surface.

11. A filter element according to claim 1, wherein the second member includes a first radially outwardly opening groove at a first end of the second member and a second radially outwardly opening groove at a second end of the second member that each receive a seal to seal the top end cap assembly to the filter head assembly and a filter bowl respectively.

12. A filter element according to claim 1, wherein the at least one stop member includes two stop surfaces at opposites ends of the stop member.

13. A filter element according to claim 1, wherein the at least one stop member includes two stop members circumferentially spaced from one another.

14. (canceled)

15. (canceled)

16. A filter assembly including:
a filter bowl having threads on an outer wall thereof;
a filter head assembly configured to be coupled to the filter bowl, the filter head assembly including a filter head and a slip thread collar, the filter head defining a cavity and having a protrusion in the cavity extending from a wall of the filter head, and the slip thread collar being disposed in the cavity and rotatable relative to the filter head, the slip thread collar having threads on an inner surface and a tab extending radially inwardly from the inner surface;
at least one end cap having a cavity defined therein, at least one groove for mating with the protrusion on the filter head to prevent rotation of the end cap relative to the filter head, and a stop member extending radially outwardly from an outer surface of the end cap, the stop member having at least one stop surface for contacting the tab; and
a filter media having one end disposed in the cavity and secured to the end cap;
wherein the at least one end cap and the filter media are disposed within the filter head assembly and filter bowl when assembled; and
wherein when the tab contacts the stop surface, the slip thread collar is prevented from rotating relative to the filter head, thereby allowing the threads on the slip thread collar to mate with the threads on the filter bowl to couple the filter head assembly to the filter bowl.

17. A filter assembly according to claim 16, wherein the filter head assembly further includes a retainer ring disposed in the cavity in the filter head for retaining the slip thread collar in the filter head.

18. A filter head assembly according to claim 17, wherein the filter head assembly further includes a slip thread locking collar disposed in the cavity in the filter head, the slip thread locking collar being configured to couple to the filter head to lock the slip thread collar and retainer ring in the filter head.

19. (canceled)

20. A filter assembly according to claim 16, wherein the at least one end cap includes:
a first member having a flange portion defining the cavity, a cylindrical portion extending from the flange portion, and a plurality of circumferentially spaced fingers extending radially outwardly from the cylindrical portion; and
a second member having an outer surface from which the at least one stop member extends and an inner surface including the at least one groove and a plurality of circumferentially spaced slots configured to mate with corresponding fingers extending from the cylindrical portion;
wherein the second member at least partially surrounds the first member when coupled thereto.

21-33. (canceled)

34. A filter assembly according to claim 16, wherein the filter head further includes first and second openings in a wall of the filter head, and wherein one of the openings is configured to receive fluid and one of the openings in configured to expel fluid.

35. A filter head assembly including:
a filter head defining a cavity, the filter head including an annular protrusion extending into the cavity from an end wall of the filter head and at least one tab extending radially outwardly from the protrusion;
a slip thread collar disposed in the cavity and rotatable relative to the filter head;
a retainer ring disposed in the cavity, the retainer ring retaining the slip thread collar in position in the filter head; and
a slip thread locking collar disposed in the cavity and coupled to the filter head to lock the slip thread collar and retainer ring in the filter head.

36. (canceled)

37. A filter head according to claim 35, wherein the slip thread collar includes threads on an inner surface that are configured to mate with threads on a filter bowl.

38. A filter head according to claim 35, wherein the slip thread collar further includes at least one tab extending radially inwardly from the inner surface, the tab being configured to contact a stop surface on an end cap assembly to prevent the slip thread collar from rotating relative to the filter head to allow the threads on the slip thread collar to mate with the threads on the filter bowl to couple the filter head assembly to the filter bowl.

39. A method of assembling a filter assembly including a filter bowl having threads on an outer wall thereof, a filter head assembly having a filter head defining a cavity and a slip thread collar disposed in the cavity and rotatable relative to the filter head, and a filter element having at least one end cap having a cavity defined therein and a filter media having one end disposed in the cavity and secured to the end cap, the method including:
inserting a first end of the filter element into the cavity of the filter head;
rotating the filter element until a groove or protrusion extending from a wall of the filter head mates with a groove or protrusion on the filter element to prevent rotation of the filter element relative to the filter head;
inserting the filter bowl into the cavity of the filter head; and
rotating the filter bowl relative to the filter head;
wherein rotating the filter bowl causes a tab on the slip thread collar to contact a stop surface on the filter element to prevent rotation of the slip thread collar relative to the filter head to allow the threads on the filter bowl to engage threads on the slip thread collar to couple the filter head assembly to the filter bowl.
